(19) United States
(12) Patent Application Publication
(10) Pub. No.: US 2005/0271997 A1
(43) Pub. Date: Dec. 8, 2005

(54) Toothbrush

(76) Inventors: Shintarou Mikami, Tokyo (JP); Masayuki Nakahara, Tokyo (JP); Hideki Iwayama, Tokyo (JP); Zenichi Onuki, Tokyo (JP); Teruhiko Kitamura, Tokyo (JP); Yasushi Fujii, Tokyo (JP)

Correspondence Address: CERMAK & KENEALY, LLP, 515 EAST BRADDOCK RD SUITE B, Alexandria, VA, 22314, US

(21) Appl. No.: 10/525,734

(22) PCT Filed: Nov. 1, 2004
(86) PCT No.: PCT/JP04/16229

§ 371 Date: Feb. 28, 2005

(30) Foreign Application Priority Data
Apr. 15, 2004 (JP) 2004-120644

(51) Int. Cl. A61C 3/00; A46B 9/04

(52) U.S. Cl. 433/29; 15/105; 15/167.1; 362/109

(57) ABSTRACT

[Problem] To provide a toothbrush, in which illumination of an interior of an oral cavity enables an assistant to grasp the state of the interior of an oral cavity of a person being assisted, and an uncomfortable strike against the interior of an oral cavity caused by a portion made of a hard material can be prevented as far as possible during brushing.

[Means for Resolution] A toothbrush 10 comprising a head portion 31 formed on a surface thereof with a brush portion 55, a toothbrush body 11, and a shaft 25 that connects the head portion and the toothbrush body, the toothbrush body being provided with light emitting means 21 to irradiate light toward the head portion, the shaft being formed to permit the light to transmit therethrough, at least a surface of the head portion being formed with elastic portions 34, 36, and a tip end of the head portion being not formed with the elastic bodies and thereby provided with a tip-end light transmitting portion 37.

### TECHNICAL FIELD

This invention relates to an improvement in a toothbrush capable of illumination in an oral cavity.

### BACKGROUND ART

A toothbrush is known to have the illuminating function of enabling brushing while illuminating an interior of an oral cavity of a person being assisted (see Patent Document 1).

Such toothbrushes largely suppose the use for adults or grown children and there are not found toothbrushes specifically contrived for use for objects including infants or the like.

Also, while there has been proposed a toothbrush, which comprises a rubber piece arranged at a tip end thereof so as not to injure gums (see Patent Document 2), such toothbrush does not take account of ease, with which an assistant brushes teeth while visually recognizing an interior of an oral cavity of a person being assisted.

Patent Document 1: JP-A-2003-47528

Patent Document 1: JP-UM-A-61-144828

### DISCLOSURE OF THE INVENTION

Problems That the Invention is to Solve

Since, for example, an infant's oral cavity is delicate, it is preferable to adopt a constitution, in which an elastic body covers a head portion made of a hard synthetic resin in order to prevent the head portion from striking against an interior of an oral cavity.

Also, in the case where an assistant performs brushing while visually recognizing and discriminating an infant's small teeth and gums, it is preferable to illuminate an interior of an oral cavity, which is spatially small and light from outside is hard to reach, and it is desirable to cover at least a head portion with an elastic body to provide for the function of protecting an interior of an oral cavity from a strike and the function of illuminating an interior of an oral cavity.

Since a light source is generally provided on a side of a toothbrush body, however, it is necessary to conduct the light to a head portion and when it is tried to irradiate light on an interior of an oral cavity from the head portion, a covered elastic body will shade the light.

In particular, for a small head portion suited to a small oral cavity of an infant or the like, it is preferred that transmission of light through a surface of the head portion be not restricted as far as possible.

This invention has been thought of in order to solve the problem described above, and has its object to provide a toothbrush, in which illumination of an interior of an oral cavity enables an assistant to grasp the state of the interior of an oral cavity of a person being assisted, and an uncomfortable strike against the interior of an oral cavity caused by a portion made of a hard material can be prevented as far as possible during brushing.

Means for Solving the Problem

The above object is attained in a first invention by a toothbrush comprising a head portion formed on a surface thereof with a brush portion, a toothbrush body, and a shaft that connects the head portion and the toothbrush body, the toothbrush body being provided with light emitting means to irradiate light toward the head portion, the shaft being structured to permit the light to transmit or pass therethrough, at least a surface of the head portion being formed with an elastic portion, and a tip end of the head portion being not formed with the elastic body and thereby provided with a tip-end light transmitting portion.

With the constitution of the first invention, an elastic body is formed on a surface of a head portion inserted into an oral cavity of a person being assisted and subjected to brushing. Here, a head portion in the structure of a toothbrush is formed from a relatively hard material under the necessity of transplantation of bristles on a brush portion. Therefore, there is a fear that a portion made of a hard material can strike against a tooth, etc. in an oral cavity during brushing to cause direct transmission of a shock and vibrations, which accompany the tooth brushing operation, but the provision of an elastic portion to cover the elastic body effectively avoids such inconvenience and causes no uncomfortable feeling and injury. Besides, light from the tip-end light transmitting portion on the head portion inserted into an oral cavity of a person being assisted illuminates, in particular, a deep side in the oral cavity, and combines with a light reflection effect in the oral cavity to be able to illuminate the interior of the oral cavity, which is spatially small and light from outside is hard to reach, so that an assistant can very easily perform the work of brushing teeth while visually recognizing them. Further, since the light transmitting portion is arranged on the tip end of the head portion, the brush portion can be placed in an appropriate position by shining light while leftovers, etc. remaining on teeth are beforehand visually recognized.

A second invention adds to the constitution of the first invention a feature that the surface of the head portion, on which the brush portion is provided, is not formed with the elastic portion and thereby formed with a brush-portion light transmitting portion, and at least a part of a surface opposed to the surface of the head portion is not formed with the elastic body and thereby provided with a back-surface light transmitting portion.

With the constitution of the second invention, light from the light transmitting portion on the brush portion illuminates an object being brushed whereby it is possible to perform an operation while recognizing teeth being brushed. Further, since light from the back-surface light transmitting portion illuminates an interior of an oral cavity, a sense of incongruity given to teeth is decreased and the operation of brushing teeth is easy to perform while illuminating the whole interior of an oral cavity appropriately bright.

A third invention adds to the constitution of the second invention a feature that the elastic body is formed on at least a part of outer peripheries of sides of the head portion and in a substantially central region of the opposed surface except the back-surface light transmitting portion.

With the constitution of the third invention, since the elastic body particularly covers locations, which are liable to strike against an interior of an oral cavity, as in the case where an opposite surface of the head portion is liable to strike against a tooth on a side opposed to a tooth being subjected to brushing when clenching surfaces of teeth are to be brushed, and in the case where sides of the head portion are liable to strike against other teeth when surfaces and back sides of teeth are to be brushed, it is possible to effectively prevent an uncomfortable strike against an interior of an oral cavity caused by a hard material while maintaining the necessary illumination effect.

A fourth invention adds to the constitution of the third invention a feature that the back-surface light transmitting portion is formed to have a cross section thereof curved from an outer periphery of a back surface of the head portion to a part of the outer peripheries of the sides, and surfaces of the elastic body project from surfaces of the respective light transmitting portions.

With the constitution of the fourth invention, since the elastic body functioning as a cushion projects from the light transmitting portion formed from a hard material it is possible to effectively prevent that uncomfortable strike against teeth or the like in an oral cavity, which is caused by a hard material. Besides, since the back-surface light transmitting portion is formed to assume a curved surface, the operation is made easy without bringing the relatively hard light transmitting portion into contact with teeth or the like, even in case of various motions such as vertical rolling of the head portion or the like in the brushing operation, etc. are conducted.

A fifth invention adds to the constitution of any one of the first to fourth inventions a feature that the elastic body forms a shaft elastic body on the shaft in the vicinity of the head portion, and a surface of the shaft elastic body opposed to the surface is not formed with the elastic body and thereby provided with a shaft light transmitting portion.

With the constitution of the fifth invention, for example, in the case where a person being assisted closes one's mouth with disgust, it is possible to effectively illuminate a side being brushed while preventing direct touch at a hard material when teeth bite the shaft.

Also, the toothbrush body may comprise a drive to transmit a drive force to the head portion through the shaft, the light emitting means, and an operating member connected to the drive and the light emitting means, and the operating member may be operated to change over the respective modes such as lighting of the light emitting means, driving of the light emitting means and the drive, and stopping of driving of the light emitting means and the drive.

Also, the above object is attained in a sixth invention by a toothbrush comprising a head portion formed on a surface thereof with a brush portion, a toothbrush body, and a shaft that connects the head portion and the toothbrush body, the toothbrush body being provided with light emitting means to irradiate light toward the head portion, the shaft being structured to permit the light to transmit or pass therethrough, at least a surface of the head portion being formed with an elastic portion, and the elastic body being formed from a transparent material.

With the constitution of the sixth invention, the elastic body is formed on a surface of the head portion inserted into an oral cavity of a person being assisted and subjected to brushing. Here, the head portion in the structure of a toothbrush is formed from a relatively hard material under the necessity of transplantation of bristles on the brush portion. Therefore, there is a fear that a portion made of a hard material can strike against a tooth, etc. in an oral cavity during brushing to cause direct transmission of a shock and vibrations, which accompany the tooth brushing operation, but the provision of the elastic portion formed as by covering of the elastic body effectively avoids such inconvenience and causes no uncomfortable feeling and injury.

Besides, light from the head portion inserted into an oral cavity of a person being assisted can illuminate, in particular, a deep side in the oral cavity. Further, since the elastic portion is formed from a transparent material, the elastic portion does not shade light irradiated outside from inside the elastic portion, so that in particular, an interior of an oral cavity is illuminated effectively bright. Therefore, an interior of an oral cavity, which is spatially small and light from outside is hard to reach, can be illuminated effectively, so that an assistant can very easily perform the work of brushing teeth while visually recognizing them.

Also, the head portion and the shaft may be formed from a hard material and the elastic portion may be formed at least in a partial region on the surface of the head portion.

Also, the head portion may be formed from a soft material, which is the same as or equivalent to that of the elastic body.

Further, the head portion and the shaft may be formed from a soft material, which is the same as or equivalent to that of the elastic body.

Also, in the head portion, the brush portion formed with a multiplicity of bristles transplanted thereon may be formed from a hard material having transparency.

Further, the elastic portion of the head portion may be formed from a soft material and the soft material may have a hardness of 10 to 70 degrees.

Further, a soft material, which forms the head portion and the shaft, may have a hardness of 60 to 90 degrees.

Furthermore, the above object is attained by an exchange toothbrush comprising a head portion formed on a surface thereof with a brush portion and a shaft, the shaft being mounted to and dismounted from a toothbrush body, the shaft being structured to permit light to transmit or pass therethrough, the head portion being formed on at least a surface thereof with an elastic portion, and a tip end of the head portion being not formed with the elastic body and thereby provided with a tip-end light transmitting portion.

Alternatively, the above object is attained by an exchange toothbrush comprising a head portion formed on a surface thereof with a brush portion and a shaft, the shaft being mounted to and dismounted from a toothbrush body, the shaft being structured to permit light to transmit or pass therethrough, the head portion being formed on at least a surface thereof with an elastic portion, and the elastic portion being formed from a transparent material.

### BEST MODE FOR CARRYING OUT THE INVENTION

Preferred embodiments of the invention will be described below in detail with reference to the drawings.

In addition, since embodiments described below constitute preferred concreter examples of the invention, they involve various technically preferable limitations but the invention is not limited in scope to these embodiments unless the invention is specifically described to be limitative in the following description.

FIG. 1 is a schematic, perspective view showing the whole of an electrically-driven toothbrush (referred below to as “toothbrush”) 10 as a first embodiment of a toothbrush,

FIG. 2 is a schematic, longitudinal cross sectional view showing the toothbrush 10,

FIG. 3 is an exploded, perspective view showing a body of the toothbrush 10, and

FIGS. 4 and 5 are schematic, perspective views showing inner parts accommodated in the body.

As shown in FIG. 1, the toothbrush 10 comprises a body 11, a lengthy shaft 25 mounted to and dismounted from the body 11, and a head portion 31 formed integral at a tip end of the shaft 25.

As shown in FIGS. 2 and 3, the body 11 comprises a hollow case, an intermediate portion and its near portion of which are made thin taking account of ease with pen-grip and which is composed of a molding made of a synthetic resin, for example, ABS (acrylonitrile-butadiene-styrene resin), AS (styrene-acrylonitrile resin), polypropylene, polyethylene terephthalate, polystyrene, polyacetal, polycarbonate, polyethersulfone, polyamide, acrylic resin, etc. ABS resin is good in mechanical properties, excellent in chemical stability, and also good in coloring quality.

A lower end 13 of the body 11 is mounted and dismounted through a sealing member such as a packing 13a, etc. by means of screwing or the like. Thereby, exchange of a battery or the like can be made by taking out and inserting inner parts 14 into the body 11 as shown in FIG. 3.

Here, a nonslip portion 11a composed of an elastic body of elastomer, silicone, etc. is formed integral with a surface of the body 11 by integral molding such as insert molding or the like. The nonslip portion 11a is arranged toward the shaft 25 such that a portion made thin near the intermediate portion thereof is centered so as to be positioned in a zone held by a thumb and a forefinger at the time of pen-gripping. In addition, since the nonslip portion 11a is arranged corresponding to the shape of the body 11, it suffices to assume a shape along portions, on which a thumb, a forefinger, etc. should be positioned when the portions are to be determined beforehand.

A switch 12 serving as an operating member is provided on an upper side of a surface of the body 11.

The switch 12 is formed to be single or plural, and, for example, only a single one is provided according to the embodiment. The switch 12 comprises, for example, a membrane switch to be waterproof-structured.

The inner parts 14 are accommodated in the body 11.

Concretely, the inner parts 14 comprise predetermined parts assembled to an elongate mechanical chassis 14a provided with an internal space 17, which is opened at one surface thereof, as shown in FIGS. 4 and 5. FIG. 4 shows one surface, through which an interior of the internal space 17 of the mechanical chassis 14a is seen, and FIG. 5 shows another surface of the mechanical chassis 14a. The mechanical chassis 14a constitutes a frame molded from, for example, ABS resin or the like to serve for assembly of parts, and comprises necessary partitions or support walls 14b, 14c, 14d, 14e, 14f and a bottom 14g to make these walls upright thereon in order to form sections, which are compartmented corresponding to the accommodated parts, as shown in FIG. 2.

A battery, for example, a dry cell 18 (see FIG. 2), serving as an electric source is mounted in and dismounted from a large space 17a in the internal space 17. As shown in FIGS. 2 and 4, that space near a tip end, which constitutes the remainder of the space in the mechanical chassis 14a, accommodates therein a motor 16 connected to the battery 18 to serve as drive means, and an eccentric weight 15 rotated and driven by the motor 16.

As shown in FIG. 5, surfaces of the mechanical chassis 14a are surrounded by flexible printed substrates (FPC) (referred below to as “substrate”) 19, 19, which comprise a backing material of a soft material such as polyimide, etc. and are formed with a necessary wiring. The respective electrical equipments described above are electrically connected together by the substrates 19, 19, and connect thereto or are formed with control circuits required for driving of the motor and operations of light emitting means described later. The substrates 19, 19, the motor 16, etc. are further fixed by band-shaped fixing means 17b.

As shown in FIG. 2, light emitting means 21 composed of, for example, a light emitting diode is mounted on an outer surface of the wall 14b, which is upright at a tip end of the mechanical chassis 14a, to be disposed on a land of the flexible printed substrate 19. The light emitting means 21 functions as a light source and is supplied with electric power of the electric source battery 18 to generate illumination light. In addition, a light emitting diode (LED) is suitable as the light emitting means 21 because it is small in power consumption, long in part life and can be made small in size, but it is not necessarily limitative and an appropriate light source such as a miniature bulb, a photoelectric tube, etc. can be selected provided that it can give a sufficient illumination light to the head portion.

A lens 22 serving as condensing means is mounted at a tip end of the case 11 in a position opposed to the light emitting means 21 in a manner to close an opening 11a thereof. The lens 22 causes light from the light emitting means 21 to be incident upon a projecting portion, described later, of the shaft 25. In addition, while the light emitting means 21 is arranged in the body 11, a distance from the light emitting means 21 to the head portion 31 may be decreased by projecting an engagement projection of the body toward the shaft, providing an engagement recess on the shaft, and arranging the light emitting means 21 at a tip end of the engagement projection.

Thereby, when the switch 12 is pushed, for example, the function of the control circuit described above enables switching of respective modes, such as a lighting mode of the light emitting means 21, a mode of lighting of the light emitting means 21 and driving of the motor, and a mode of driving and stopping of light emitting means 24 and the motor in the order of operations of the switch 12. Thereby, the switch 12 is operated for illumination whereby a dirty state and a structure in an oral cavity cannot only be first confirmed but also brushing can be performed while an interior of the oral cavity is illuminated by the operation of the switch 12. According to the purpose, it is possible to use only the illuminating function to make effective use of the electric source without waste and only by the operation of the switch 12, to make properly use of the functions and perform a series of successive operations. In addition, a plurality of switches may be provided and the respective operational modes described above may be allotted to each switch.

FIGS. 6 and 7 show an example of a construction for mounting and dismounting of the shaft 25 and the body 11, FIG. 6 being a schematic, perspective view showing the manner of mounting and dismounting of the shaft and the body, and FIG. 7 being a schematic, perspective view showing a removable structure on a side of the body in detail.

As shown in FIGS. 2 and 6, the shaft 25 is in the form of a lengthy, thin rod, comprises a head portion 31 integrally formed at a tip end thereof, is increased slightly in diameter as it goes toward a base end opposed to the tip end, and further comprises a shaft-side removable portion 28 at the base end. The shaft 25 has a total length of the order of, for example, 55 mm and an outside diameter of the order of 7 mm to 9 mm at a thickest location of the base end, and an outside diameter of the order of 2 mm to 6 mm around an intermediate portion thereof

The head portion 31 and the shaft 25 constitute an exchange brush to be mounted to and dismounted from the body 11.

The shaft 25 is structured to pass or transmit light lengthwise. That is, a part or a whole of the shaft 25 may be made into a hollow cylinder to pass light therethrough, or the whole shaft 25 may be made of a light transmissive material to transmit light therethrough.

In this case, a material for formation of the body 11 is not limited to a transparent synthetic resin but any kind of material will do provided that it has the function of conducting illumination light from the light emitting means to the head portion as described later. For example, the body may be formed from not only a transparent material but also a light transmissive material, which is frequently used to constitute a light guide. Also, of course, as far as such function is not hindered, surfaces of the body 11 and/or the shaft 25 may be of course colored, and patterns and drawings may be drawn thereon.

According to the embodiment, the shaft 25 is formed from a light transmissive material, for example, polyethylene terephthalate (PET) as a transparent synthetic resin. Additionally, the shaft can be formed from, for example, ABS resin, AS resin, polypropylene, polystyrene, polyacetal, polycarbonate, polyamide, acrylic resin, mecrylic resin, styrene resin, etc.

In addition, in case of use for infant, the shaft is required to have a small outside diameter so as not to give a sense of incongruity in an oral cavity and the shaft 25 is preferably formed to be solid with the use of a transparent material, while in case of a toothbrush used for assistance in nursing, the shaft 25 may be formed from an opaque material to have a relatively large outside diameter and to be cylindrical and hollow inside, thus providing for light transmission.

In this case, the shaft-side removable portion 28 provided on the shaft 25 comprises a rod-shaped shaft-side projection 26 configured to extend lengthwise in a manner to project outside from a flange 29 formed near a lower end of the shaft 25. The shaft-side projection 26 is formed on an outer peripheral surface thereof with radially outwardly projecting latch pieces 27, and the latch pieces 27 shown in FIG. 6 are provided in a pair such that one is likewise formed in a symmetric position on an opposite hidden surface in the figure.

The shaft-side projection 26 is made removable upon insertion thereof into a body-side removable portion 41.

As shown in FIGS. 6 and 7, the body-side removable portion 41 comprises a first portion 61 and a second portion 42.

The first portion 61 shown in FIG. 7 is formed by means of integral molding with the body 11. The first portion 61 comprises an opening 65 provided centrally thereof to extend lengthwise of the body 11, struts 62, 62 standing upright in symmetric positions on a circumference around a periphery of the opening, a ring 68 formed circumferentially on upper ends of the respective struts 62, 62, and stoppers 63, 64 on the ring 68 to be formed in the vicinity of the respective struts 62, 62 in a penthouse-shaped manner to be increased in width and decreased in thickness. The opening 65 constitutes a portion to receive therein the shaft-side projection 26 as shown in FIG. 2.

Also, the first portion 61 comprises deformation portions 66 in symmetric positions nearer to the body 11 than to the ring 68 to extend circumferentially in an arm-like manner with the respective struts 62, 62 as base ends.

The deformation portions 66 comprise a first projection 66a and a second projection 66c provided near tip ends thereof to be close to each other, and a recess 66b between the first projection 66a and the second projection 66c. The deformation portions 66 are configured such that base ends thereof are put in a fixed state and tip ends thereof can be deformed by elasticity thereof to swing inside and outside.

The body-side removable portion 41 further comprises latch means 42 serving as a second portion to be mounted to and dismounted from the first portion 61. As shown in FIGS. 6 and 7, according to the embodiment, the latch means 42 is a ring-shaped member provided centrally thereof with an opening 47. The latch means 42 comprises a side wall 49 and a lid 48 that closes a tip end side except the opening 47, the side wall 49 being formed with two pairs of inwardly projecting ribs 43, 44, 45, 46. A clearance S1 is formed between the ribs 43, 45 and the lid 48. As described later, the lid 48 serves as latch means to hold the latch pieces of the shaft-side projection 26.

An explanation will be given to an operation of mounting and holding the shaft 25 to the body 11 to fix the same in a manner to make displacement impossible in such construction.

First, as shown in FIG. 6, the latch means 42 serving as the second portion in the body-side removable portion 41 is fitted onto the first portion 61 in a covering manner, and notches 65a on the opening 65 of the first portion 61 are caused to mate with notches 47a on the opening 47 of the latch means 42. In this state, as shown in FIG. 6, the shaft-side projection 26 of the shaft 25 is passed through and inserted into the respective openings 47, 65. In this case, the respective latch pieces 27 on the shaft-side projection 26 are passed through and inserted into the respective notches 47a, 65a of the respective openings 47, 65 (see FIG. 2).

Subsequently, when the latch means 42 is turned around the first portion 61, outer edges of the stoppers 63, 64 on the first portion 61 enter the clearance S1 between the ribs 43, 45 of the latch means 42 and the lid 48. Thereby, the latch means 42 is held by the first portion 61. At the same time, positions of the notches 47a of the opening 47 on the latch means 42 are shifted in a direction of rotation. Thereby, the respective latch pieces 27 on the shaft-side projection 26 are restricted by the lid 48 of the latch means 42, so that the shaft 25 is held by the body 11 and does not come off.

At this time, the ribs 44, 46 projecting inward from the side wall of the latch means 42 thus turned get over the first projections 66a, 66a of the deformation portions 66 on the first portion to enter the recesses 66b, 66b. Thereby, tip ends of the deformation portions 66, respectively, are deformed inward to abut against the respective latch pieces 27, 27 of the shaft-side projection 26, which pass centrally, to clamp the same. Thus, the shaft-side projection 26 is firmly fixed, so that it can be used for tooth brushing without hindrance.

Also, when the latch means 42 is turned, the ribs 43, 45 are disengaged from the recesses 66b, 66b of the deformation portions 66, 66 and get over the first projections 66a, 66a in an opposite direction. Thereby, the respective deformation portions 66, 66 return to original positions due to elasticity, so that they will not abut against the shaft-side projection.

Further, when the latch means 42 is relatively turned, the ribs 44, 46 also get over the respective first and second projections 66a, 66c of the deformation portions 66, 66 on the first portion, and the ribs 44, 46 strike against the struts 62 of the stopper 64 since there is no clearance S1. In this state, the clearance S1 about the ribs 43, 45 on the latch means 42 is shifted to a position not to overlap the stoppers 63, 64 of the first portion, so that the shaft-side projection 26 can be pulled out from the body 11 as shown in FIG. 6 and the latch means 42 can also be dismounted from the first portion 61.

FIGS. 8 and 10 show a constitution of the head portion 31 according to a first embodiment of the toothbrush 10, FIG. 8 being a schematic, perspective view as viewed from a brush surface, FIG. 9 being a schematic, perspective view as viewed from a head back surface side, and FIG. 10 being a view as viewed from a tip end side of the head portion 31.

As described previously, illumination light from the light emitting means 22 accommodated in the body 11 passes through the lens 22 to be incident upon the shaft-side projection 26 of the shaft 25 in FIG. 2. The illumination light incident upon the shaft-side projection 26 transmits through the shaft 25 lengthwise to be conducted to the head portion 31.

In FIGS. 8 and 9, the head portion 31 is formed from the same material as that of the shaft 25 by means of integral molding. That is, the head portion 31 is made of polyethylene terephthalate (PET resin) to be contiguous from the shaft 25, and formed by enlarging a tip end of the shaft 25 in width to assume a circle, an ellipse, or an oval as shown in the figure.

A brush portion 55 with a multiplicity of bristles transplanted thereon is formed on a surface 32, which defines an upper surface of the head portion 31 in FIG. 8. Soft bristles for formation of the brush portion 55 are preferably selected in order to be suited to infants or the like, and can be made of nylon, saturated polyester resin, polybutylene terephthalate, etc. Thickness of bristles is made as small as around 0.06 mm in contrast to a thickness of 0.15 mm of bristles of conventional brushes, and tip ends of the bristles are rounded to define a curved surface, whereby the bristles are caused to enter small gaps between teeth without injuring infant's gums. Bristles have a length of, for example, around 5 mm to provide for a suitable stiffness while being soft and the head portion 31 is made small in external form to afford easy operation in a small infant's oral cavity. A lengthwise dimension of the brush portion 55 is made around 6 mm in contrast to a conventional dimension of around 12 mm to be substantially in the same order as that of a width of an infant's front tooth, so that it is possible to easily put the brush portion on a small tooth.

The head portion 31 is generally made of a transparent material but a part of the surface thereof is covered by an elastic body to provide for an elastic portion.

That is, a material such as the above resin to constitute the head portion 31 is relatively hard under the necessity for transplantation of bristles on the brush portion 55. Therefore, such portion made of a hard material can strike against a tooth, etc. in an oral cavity during tooth brushing to cause direct transmission of a shock and vibrations, which accompany the tooth brushing operation. The elastic portion is provided in order to eliminate such inconvenience.

Since the elastic portion is provided for such reason, it can be formed on, for example, all the surface of the head portion 31 except a region of the brush portion 55. According to the embodiment, however, in order to offer convenience for illumination in an oral cavity in the case where an assistant performs tooth brushing, respective transmitting portions for transmission of illumination light therethrough are partially formed so that illumination light from the light emitting means 21 described above is conducted to the head portion 31 to illuminate an interior of the oral cavity to enable the assistant to perform the brushing operation while confirming the state in the oral cavity.

Here, the elastic portion provided on the surface of the head portion 31 is formed by using integral molding such as insert molding, two-color molding, etc. to cover a predetermined region on the surface of the head portion 31 with an elastic material such as elastomer, for example, SEBS resin (styrene/ethylene/butadiene/styrene), SBS resin (styrene/butadiene/styrene), SEPS resin (styrene/ethylene/propylene/styrene), silicone, or the like. The elastic portion has a surface hardness of 10 to 70 degrees, preferably of 20 to 50 degrees in the type A durometer test according to JIS-K6253 (ISO7619).

According to the embodiment, a back-surface elastic portion 36 is formed in and around a center of a back surface 33 shown in FIG. 9 where the brush portion 55 is not formed. Thereby, the elastic body covers that portion having a large area, which is liable to strike on other teeth, gums, etc. in an oral cavity during brushing, to protect the oral cavity from a hard material whereby it is hard to give a sense of incongruity to a clenching side of teeth on an opposite side, in particular, when the clenching side of teeth is brushed.

Also, side elastic portions 34, 34 are formed on outer peripheries of both sides of the head portion 31. The side elastic portions 34, 34 appropriately cover other surfaces than those surfaces, which are provided with no bristles, to prevent an uncomfortable shock caused by a strike of such surfaces against an oral cavity, in particular, when the head portion 31 is moved during brushing.

Further, a shaft elastic portion 39 is also formed on the shaft 25 near the head portion 31. The shaft elastic portion 39 is provided in view of the fact that a strike against teeth or the like is caused in a location corresponding to a neck on the shaft 25 as well as the head portion.

That is, even in the case where a person, such as an infant, being assisted closes one's mouth with disgust, direct touch at the shaft 25 made of a hard material is prevented when teeth bite the shaft 25, or so.

Simultaneously with formation of the respective elastic portions, light transmitting portions are formed in predetermined regions on surfaces of the head portion 31.

That is, as shown in FIG. 9, a tip-end light transmitting portion 37 is formed at the tip end of the head portion 31 between the side elastic portions 34, 34 provided on the respective sides thereof. The tip-end light transmitting portion 37 enables illumination light to illuminate an interior of an oral cavity prior to insertion of the head portion 31 into the oral cavity to visually recognize a tooth being brushed to brush the tooth and to illuminate a region, which is positioned deepest and light from outside is most hard to reach, when the head portion 31 is inserted into the oral cavity.

Also, as shown in FIG. 9, a back-surface light transmitting portion 38 is formed along that outer periphery of the back surface 33 of the head portion 31, which constitutes a region except the back-surface elastic portion 36, in a manner to be made contiguous to the tip-end light transmitting portion 37.

Therefore, since not only a surface being brushed but also a back surface side thereof are illuminated as far as possible during brushing, an assistant easily catches information in the oral cavity to be able to perform the operation of moving a location being brushed while confirming a state of a location being subsequently brushed.

Further, the back-surface light transmitting portion 38 is formed not only on the back surface 33 of the head portion 31 but also continuously to a part of the side of the head portion, so that a cross section extending from an outer periphery of the back surface of the head portion 31 to a part of an outer periphery of the side thereof assumes a curve. That is, the outer periphery extending from the back surface 33 of the head portion 31 to the side thereof is formed as the back-surface light transmitting portion 38, which is shaped to define a curved surface. Besides, as shown in FIGS. 9 and 10, the side elastic portions 34 and the back-surface elastic portion 36 project beyond the back-surface light transmitting portion 38 and the tip-end light transmitting portion 37 and are configured to have corners of curved surfaces. Therefore, while the illumination effect for illumination in an oral cavity is ensured, operations are easy to perform without bringing the relatively hard light transmitting portions into contact with teeth or the like even in the case where various motions such as vertical rolling of the head portion 31, etc. are made in the brushing operation or the like.

Also, as shown in FIG. 8, a brush-portion light transmitting portion 56 is formed on the surface 32, on which the brush portion 55 of the head portion 31 is provided. The brush-portion light transmitting portion 56 includes a region, on which bristles of the brush portion 55 are transplanted, and extends from a periphery of the region to a part of the both sides of the head portion 31. A region being brushed presently is preponderantly illuminated by the brush-portion light transmitting portion 56 to enable an assistant to perform an operation while clearly grasping a dirty state of such region.

Besides, the shaft elastic portion 35 provided on the neck of the shaft 25 ends on a side of the brush surface 32 in a band-shaped manner as shown in FIG. 8 to form a shaft light transmitting portion 39 defining a region, in which the shaft 25 is exposed. In this manner, a surface side being brushed is illuminated over an as large area as possible. Also, by thus forming the shaft light transmitting portion 39, the relatively thin shaft 25 is prevented from being broken due to a problem in strength.

FIG. 11 shows a modification of the head portion according to the first embodiment.

In the figure, constituents common to those in the embodiment are denoted by the same reference numerals, and an overlapping explanation therefor is omitted.

A head 31-1 shown in FIG. 11 includes a different region, in which an elastic portion is formed, and the remaining constitution is the same as that in the above embodiment. With the head portion 31-1, a substantially semi-spherical-shaped tip-end light transmitting portion 37 is provided on a tip end of the head portion 31-1 and an elastic portion 57 makes a back surface and side surfaces of the head portion except the light transmitting portion. That is, the elastic body covers the brush including the shaft 25, except the tip-end light transmitting portion 37 and the brush-portion light transmitting portion 56.

This modification provides a constitution, in which relief of a strike caused by a hard material in an oral cavity is given much weight, illumination light is irradiated at least from the tip end of the head portion and the brush surface to illuminate a deep area in an oral cavity and a portion being brushed, and the shaft 25 is completely covered by the elastic body to make it hard to give a sense of incongruity in the case where the shaft is bitten by teeth.

FIGS. 12 to 15 show an essential part of a second embodiment, and since a constitution except a constitution shown is the same as that in the first embodiment, an overlapping explanation therefor is omitted and an explanation will be given mainly to a difference. FIG. 12 is a schematic, perspective view showing a head portion as viewed from a brush surface, FIG. 13 is a schematic, perspective view showing a head portion as viewed from a back surface of the head portion, FIG. 14 is a view showing an end surface taken along the line A-A in FIG. 12, and FIG. 15 is a view showing an end surface taken along the line B-B in FIG. 12.

In this embodiment, an elastic portion formed on the head portion is formed on all the surface of the head portion 231 except a region of a brush portion 55.

Besides, according to the embodiment, in order to offer convenience for illumination in an oral cavity in the case where an assistant performs tooth brushing, illumination light from the light emitting means 21 is conducted to the head portion 231 in the same manner as in the first embodiment to illuminate an interior of the oral cavity to enable the assistant to perform the brushing operation while confirming the state in the oral cavity. Besides, unlike the first embodiment, the elastic portion is formed to be made transparent so as not to shade illumination light as far as possible.

Here, the elastic portion formed on the surface of the head portion 231 is formed by integral molding such as insert molding, two-color molding, etc. to cover a predetermined region on the surface of the head portion 31 with the same elastic material as that in the first embodiment so that the quality as a soft material is given. However, the material is made transparent at least in a covering state.

As understood with reference to FIGS. 12 to 14, according to the embodiment, the head portion 231 is structured such that an elastic body 134 made of a transparent soft material covers a surface of a base material 139 made of a hard material such as PET or the like to be formed integral with the shaft 25, and the elastic portion 134 is formed over a back surface and both side surfaces except a bristle transplanted surface 132 formed with the brush portion 55.

That is, as shown in FIG. 13, since the elastic portion 134 is formed on the back surface 133 of the head portion 231, the elastic body covers that portion having a large area, which is liable to strike on other teeth, gums, etc. in an oral cavity during brushing, to protect the oral cavity from a hard material, so that it is hard to give a sense of incongruity to a clenching side of teeth on an opposite side, in particular, when the clenching side of teeth is brushed.

Also, as shown in FIGS. 12 and 14, elastic portions 134 are formed on sides (both sides) of the head portion 31. In movements of the head portion 231 during brushing, in particular, when the head portion 231 is moved during brushing since the surfaces other than the back surface 133 is coverd with the elastic body, it is able to prevent an uncomfortable stimulus caused by a strike of such portions against an oral cavity.

In addition, the reference numeral 136 in FIG. 14 denotes holes, in which bristles of a brush are transplanted.

Also, as shown in FIG. 14, edges 134a of the elastic portion 134 on the sides of the head portion 231 are formed to project from a base material 139, and the elastic portion 134 is surely molded integrally with the base material 139, whereby peeling-off is not only prevented but also the bristle transplanted surface 132, to which a hard material is exposed, is restricted from abutting against, for example, teeth or the like.

Further, a shaft elastic portion 135 is also formed on the shaft 25 in the vicinity of the head portion 231. The shaft elastic portion 135 is provided in view of the fact that a strike against teeth or the like is caused in a location corresponding to a neck on the shaft 25 as well as on the head portion.

That is, even in the case where a person, such as an infant, being assisted closes one's mouth with disgust, direct touch at the shaft 25 made of a hard material is prevented when teeth bite the shaft 25.

Further, as shown in FIG. 12, the elastic portion 134 is not provided on the entire circumference of the neck of the shaft 25, that is, the elastic portion 134 is not provided on an inside surface of the neck, that is, a surface in the same position as the bristle transplanted surface 132 as shown in FIG. 15. In such portion, the base material 139 forms a rib 137, which is slightly depressed relative to the elastic portion 134 and projects beyond a surface, on which the elastic portion 134 is arranged. Thereby, that portion of the neck of the shaft 25, which is made thin by provision of the elastic portion 134, is reinforced and prevented from abutting against teeth.

In this manner, according to the embodiment, while the portions made of a hard material are almost covered by an elastic material, light from the head portion 231 inserted into an oral cavity of a person being assisted can illuminate, in particular, a deep side in the oral cavity. Further, since the elastic portion 134 is formed from a transparent material, it does not shade light irradiated outside from inside the head portion, and an interior of an oral cavity is particularly effectively illuminated, so that an interior of an oral cavity, which is spatially small and hard to make outdoor daylight reach, can be effectively illuminated and an assistant can very easily perform the operation of brushing teeth while visually recognizing them.

Also, according to the embodiment, the elastic portion 134 may cover the whole except a region (a region at the bristle transplanted base end) of the brush portion 55. With such constitution, it is possible to completely prevent the inconvenience due to the fact that a hard material, which forms the base material 139, strikes against teeth, etc. in an oral cavity.

FIGS. 16 to 18 show an example of a constitution of a head portion 331 according to a third embodiment of the toothbrush 10, FIG. 16 being a schematic, perspective view as viewed from a back surface of the head portion, FIG. 17 being a schematic, perspective view showing the head portion as viewed from a brush surface, and FIG. 18 being a view showing an end surface taken along the line C-C in FIG. 17.

In these figures, since constituents denoted by the same reference numerals as those in the second embodiment are common thereto, an overlapping explanation therefor is omitted, and an explanation will be given mainly to a difference.

In these figures, the third embodiment is different from the second embodiment in that any base material is not used for the head portion 331 and a transparent, elastic portion 138 constitutes a shaft 25 and the head portion 331 as a whole. A material to constitute the elastic portion 138 is selected from ones common to the elastic portion 134 in the second embodiment and suited to integral molding of the head portion 331 and the shaft 25.

While the embodiment can fundamentarily exhibit the same function and effect as those in the second embodiment, it can completely prevent an inconvenience caused upon striking of a hard material portion against teeth, etc. in an oral cavity because the head portion 331 and the shaft 25 except the brush portion are generally made of a transparent, soft material.

Also, as compared with the case where the elastic portion is formed by partial covering of a soft, transparent material after a head portion is molded of a hard material, not only the manufacture is easy but also the shaft 25 can be slightly deformed, so that it is possible to suppress an intense stimulus given to gums or the like in use.

Here, a soft material to form both the shaft 25 and the head portion 331 has a hardness of 60 to 90 degrees, preferably of 70 to 80 degrees in the type A durometer test according to JIS-K6253 (ISO7619), and thus a harder material is used as compared with the elastic portion 134 in the first embodiment.

That is, an appropriate hardness is chosen in order not only to protect teeth, etc. but also to surely hold bristles on the brush portion 55 and to prevent incapability of the operation due to inadvertent deformation of the shaft 25 or the like in use.

In addition, in this case, a shaft-side removable portion 28 on the shaft 25 is preferably structured to be able to be surely fixed to the body 11 by integral molding with a hard material and adopting a more sure fixing method.

FIGS. 19 to 21 show an example of a constitution of a head portion 431 according to a fourth embodiment of the toothbrush 10, FIG. 19 being a schematic, perspective view as viewed from a back surface of the head portion, FIG. 20 being a schematic, perspective view showing the head portion as viewed from a brush surface, and FIG. 21 being a view showing an end surface taken along the line D-D in FIG. 21 and integral molding of the head portion.

In these figures, the fourth embodiment is different in the same manner as the third embodiment, and constructed such that any base material is not used for a shaft 25 and a body of the head portion 431 and a transparent, elastic portion 142 is structured to extend over the shaft 25 and the body of the head portion 431. A material to form the elastic portion 142 is the same as that in the third embodiment.

The fourth embodiment is different from the third embodiment in that according to the fourth embodiment a bristle transplanted base 141 (a base provided with holes 136 for bristle transplantation) to have bristles of a brush portion 55 transplanted thereon is formed of a hard material unlike the elastic portion 142.

As a method of manufacture thereof, as shown in FIG. 21, formation can be made by arranging an inner core 43 in metallic dies 144, 145, first molding the bristle transplanted base 141, thereafter setting the molded bristle transplanted base 141 so that projections of the inner core 43 can be accommodated in the holes 136 for bristle transplantation, and molding a material for the elastic portion 142 outside the bristle transplanted base 141 in a stripe-like manner.

While the embodiment can fundamentarily exhibit the same function and effect as those in the second embodiment, it can completely prevent an inconvenience caused upon striking of a hard material portion against teeth, etc. in an oral cavity in the same manner as the third embodiment because the head portion 431 and the shaft 25 except the bristle transplanted base 141 are generally made of a transparent, soft material.

Also, since bristles of the brush portion 55 are transplanted in the holes of the bristle transplanted base 141 and the transplanted bristles are supported by the bristle transplanted base 141, the bristles are hard to come off as compared with the third embodiment, so that a tough structure can be realized and a somewhat softer material than that in the third embodiment can be selected for an elastic portion on the shaft 25 or the like.

Besides, as shown in FIG. 21, since the elastic portion 142 can be arranged so as to extend to a side of a bristle transplanted surface 132, it is possible to suppress a stimulus given to gums or the like to substantially the same extent as that in the third embodiment.

The respective constitutions in the respective embodiments and the modifications described above may be implemented by partially omitting need, or being replaced by other constitutions and in a combination of different constitutions.

Unlike the embodiments described above, an elastic portion may be provided only on a back surface of a brush portion and sides of the brush portion may be structured as a light transmitting portion, or may be arranged conversely. Further, brush portions may be provided on both surfaces to serve as light transmitting surfaces and an elastic portion may be provided only on sides of the brush portions.

Also, in the case where a tip-end light transmitting portion is formed, other elastic portions may be arranged in various surface configurations such as dot-shaped one, stripe-shaped one, or the like, and irregularities may be further formed on the elastic portions.

Further, while the embodiments described above relate to electrically-driven toothbrushes, the invention is not limited to electrically-driven ones but can be of course applied to ordinary toothbrushes, which are not electrically driven, by providing for a lighting function.

An elastic portion provided on a head portion or the like may be arranged in various surface configurations such as dot-shaped one, stripe-shaped one, or the like, and irregularities may be further formed on the elastic portion.

While the embodiments described above relate to electrically-driven toothbrushes, the invention is not limited to electrically-driven ones but can be of course applied to ordinary toothbrushes, which are not electrically driven, by providing for a lighting function, and it does not matter whether a method of driving an electrically-driven toothbrush is a different driving method.

### BRIEF DESCRIPTION OF THE DRAWINGS

FIG. 1 is a schematic, perspective view showing a toothbrush according to an embodiment of the invention.

FIG. 2 is a schematic, cross sectional view showing the toothbrush of FIG. 1.

FIG. 3 is an exploded, perspective view showing a body of the toothbrush of FIG. 1.

FIG. 4 is a schematic, perspective view showing inner parts of the toothbrush of FIG. 1.

FIG. 5 is a schematic, perspective view showing inner parts of the toothbrush of FIG. 1.

FIG. 6 is a schematic, perspective view showing the mounting and dismounting construction of a shaft and a body of the toothbrush of FIG. 1.

FIG. 7 is a schematic, perspective view showing a body-side removable portion of the toothbrush of FIG. 1.

FIG. 8 is an enlarged, schematic perspective view showing a head portion according to a first embodiment of the toothbrush of FIG. 1.

FIG. 9 is an enlarged, schematic perspective view showing a head portion of the toothbrush of FIG. 1.

FIG. 10 is an enlarged, schematic front view showing the head portion of the toothbrush of FIG. 1.

FIG. 11 is an enlarged, schematic perspective view showing a modification of the head portion of the toothbrush of FIG. 1.

FIG. 12 is an enlarged, schematic perspective view showing a head portion according to a second embodiment of the toothbrush of FIG. 1.

FIG. 13 is an enlarged, schematic perspective view showing the head portion according to the second embodiment of the toothbrush of FIG. 1.

FIG. 14 is a view showing an end surface taken along the line A-A in FIG. 12.

FIG. 15 is a view showing an end surface taken along the line B-B in FIG. 12.

FIG. 16 is an enlarged, schematic perspective view showing a head portion according to a third embodiment.

FIG. 17 is an enlarged, schematic perspective view showing the head portion according to the third embodiment.

FIG. 18 is a view showing an end surface taken along the line C-C in FIG. 17.

FIG. 19 is an enlarged, schematic perspective view showing a head portion according to a fourth embodiment.

FIG. 20 is an enlarged, schematic perspective view showing the head portion according to the fourth embodiment.

FIG. 21 is a view showing an end surface taken along the line D-D in FIG. 20.

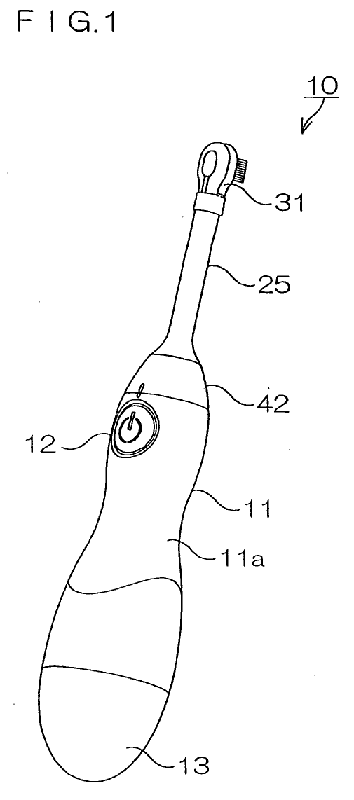

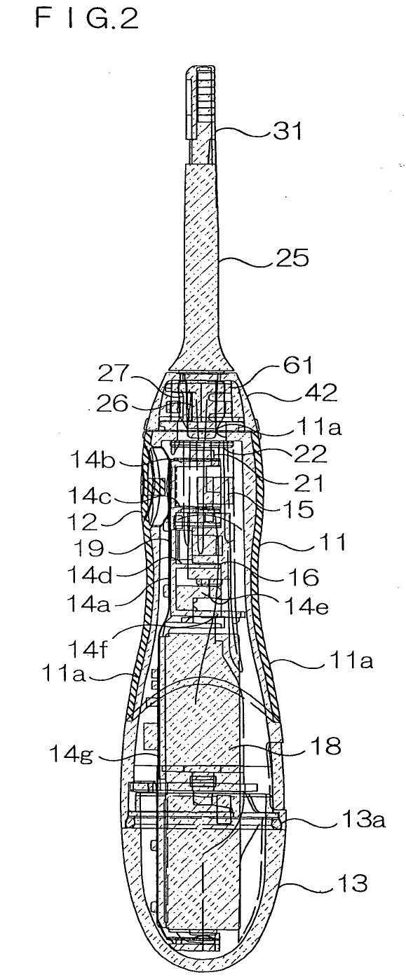

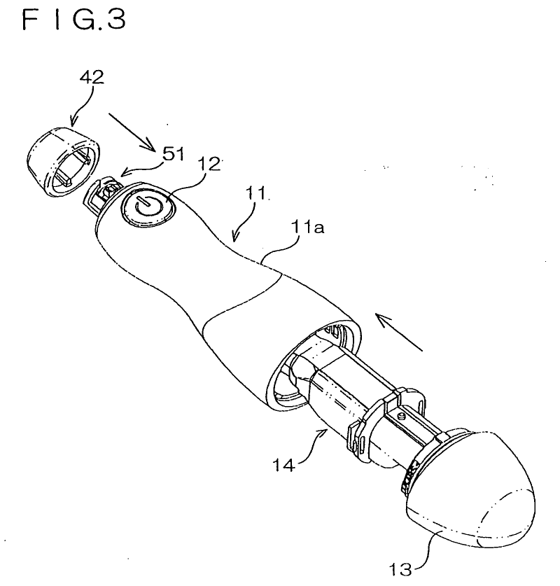

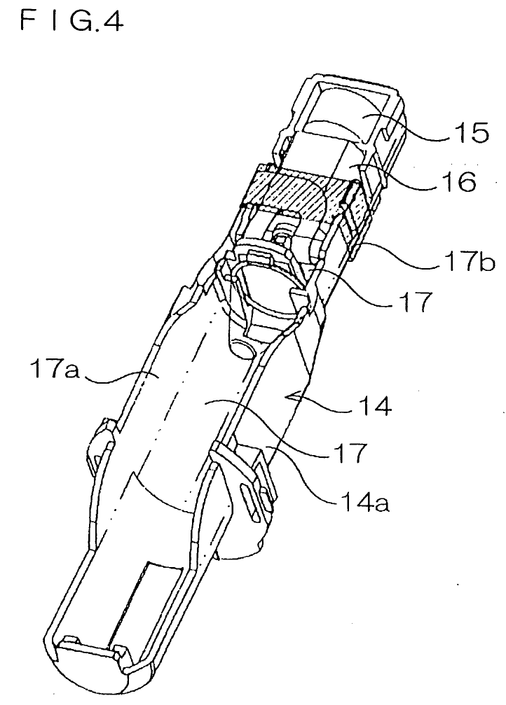

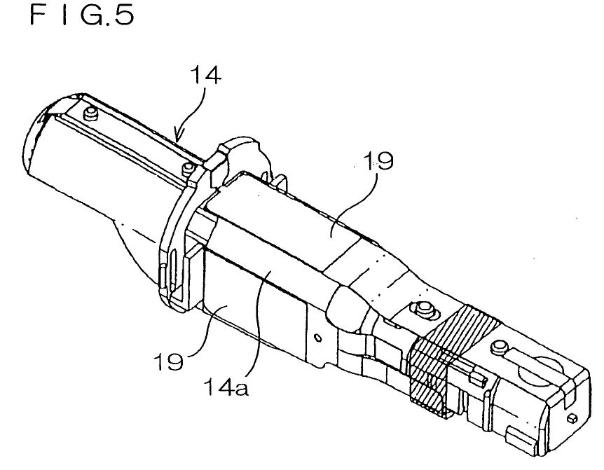

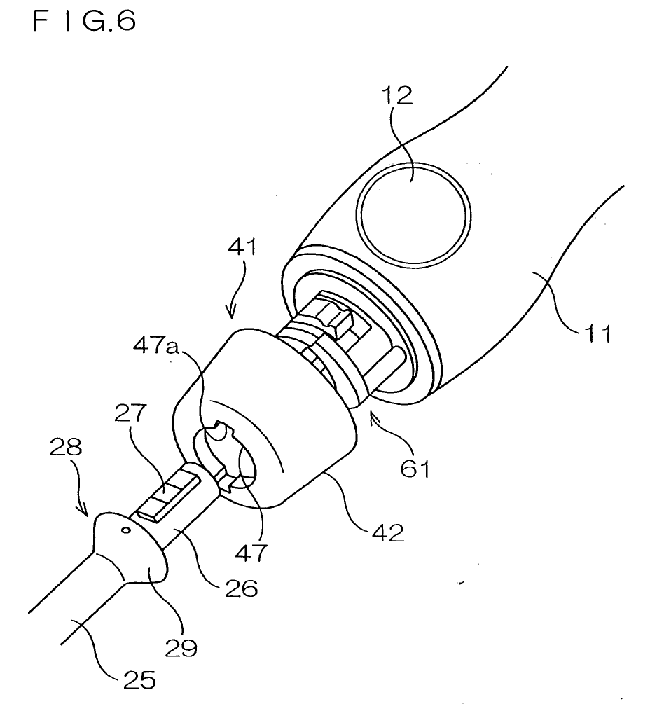

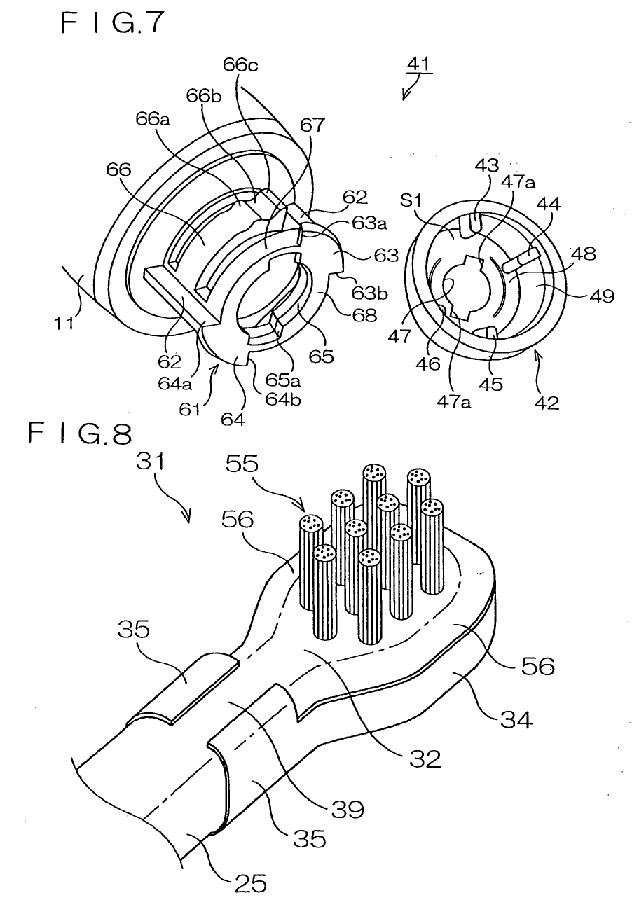

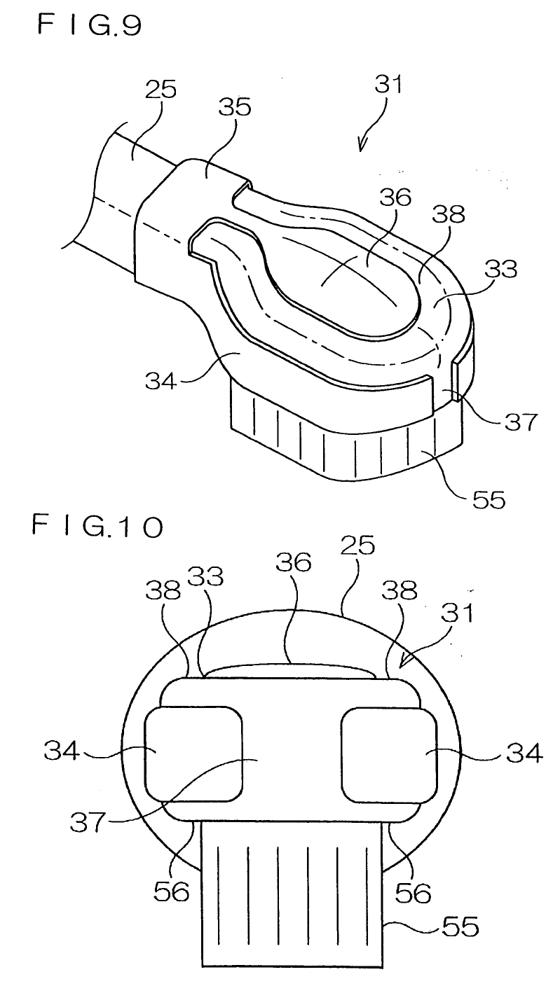

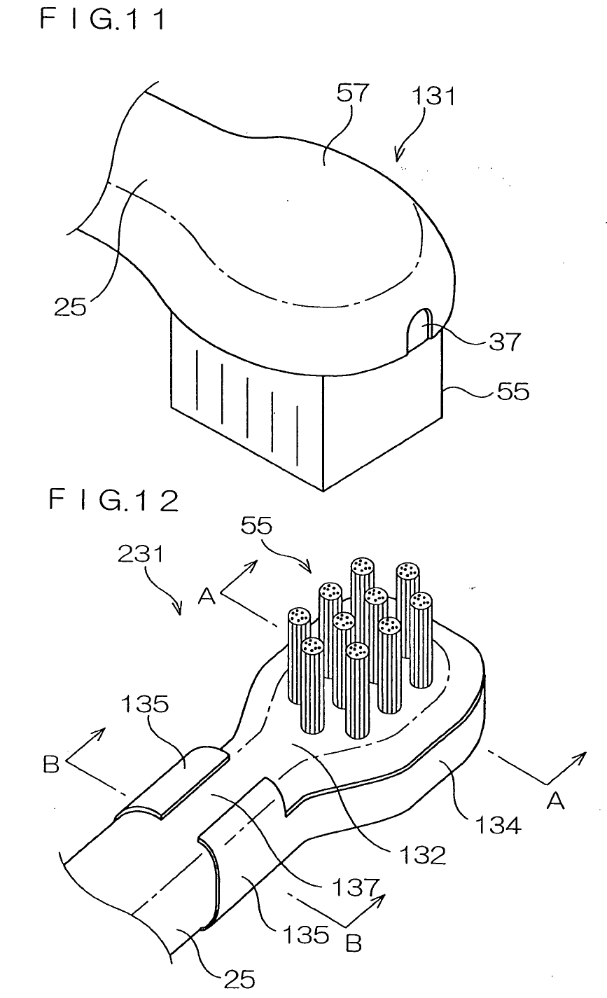

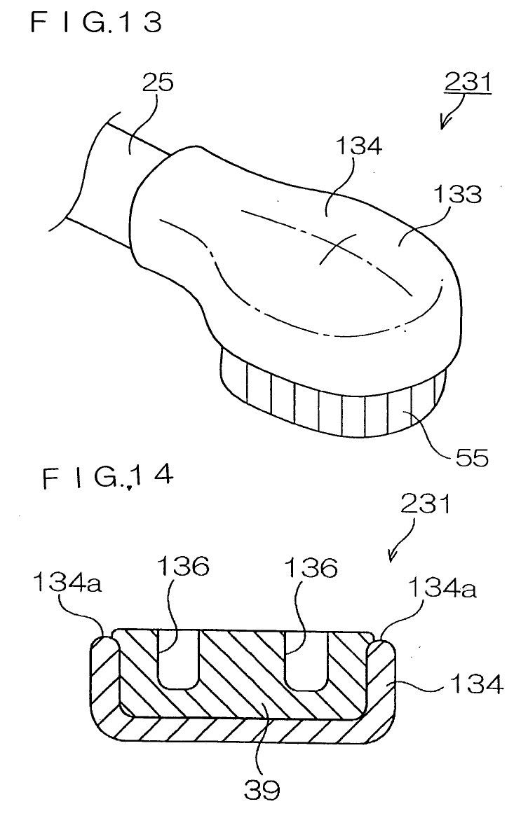

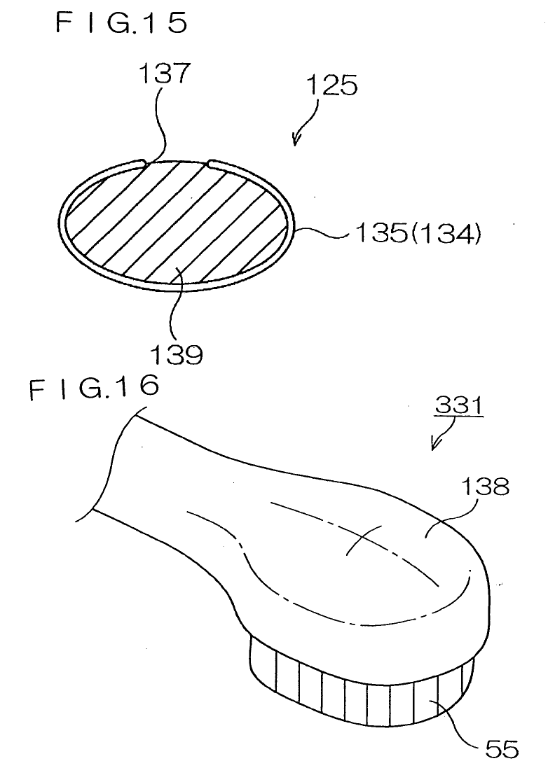

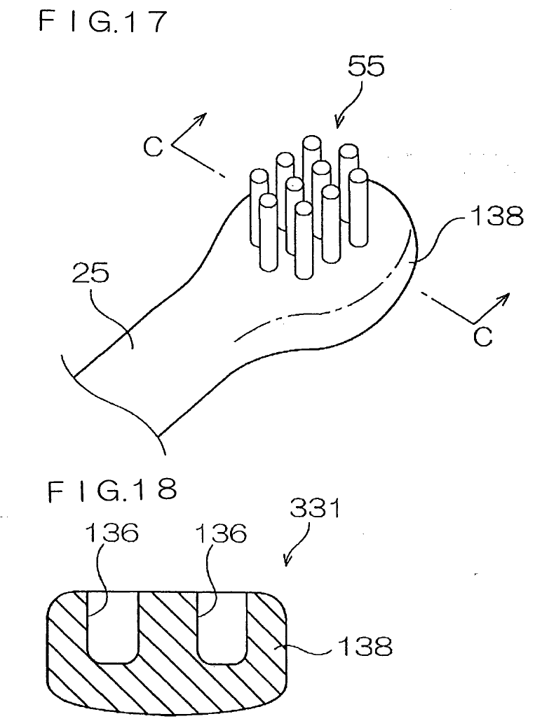

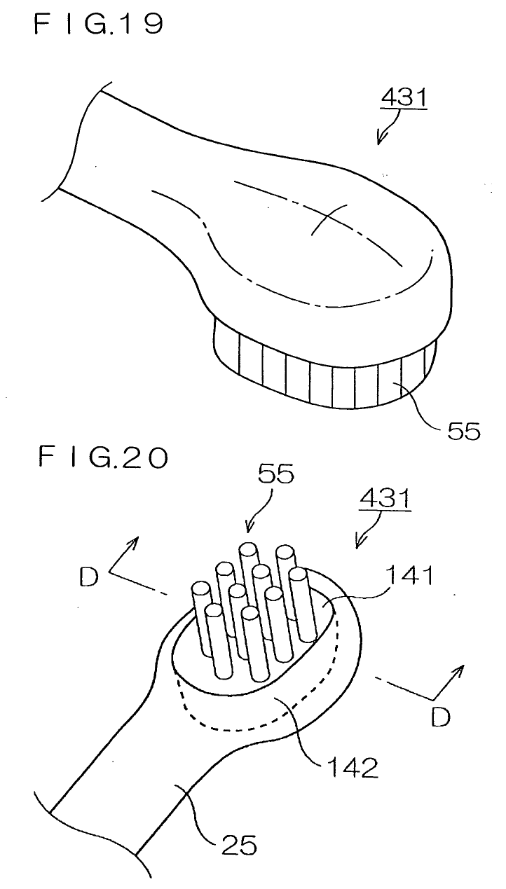

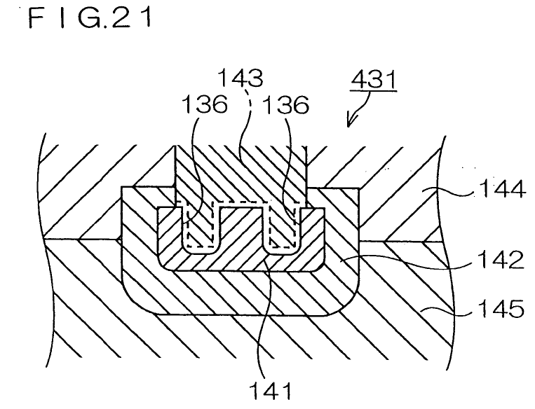

### DESCRIPTION OF REFERENCE NUMERALS AND SIGNS

10: toothbrush, 11: body, 12: switch, 14: inner parts, 21: light emitting means, 25: shaft, 26: shaft-side projection, 28: shaft-side removable portion, 31: head portion, 32: brush surface, 33: back surface (of head portion), 34: side elastic portion, 35: shaft elastic portion, 36: back-surface elastic portion, 37: tip-end light transmitting portion, 38: back-surface light transmitting portion, 41: body-side removable portion, 42: (second portion) latch means, 55: brush portion, 61: first portion, 66: deformation portions

1. A toothbrush comprising a head portion with a brush portion located on a surface thereof, a toothbrush body, and a shaft that connects the head portion and the toothbrush body,
the toothbrush body being provided with light emitting means to irradiate light toward the head portion, the shaft being structured to permit the light to transmit or pass therethrough,
at least a surface of the head portion including an elastic portion located thereon, and
a tip end of the head portion not including the elastic portion located thereon and thereby provided with a tip-end light transmitting portion.

2. The toothbrush according to claim 1, wherein the surface of the head portion on which the brush portion is provided, does not include the elastic portion and is thereby formed with a brush-portion light transmitting portion, and at least a part of a surface opposed to the surface of the head portion on which the brush portion is provided does not include the elastic portion and is thereby provided with a back-surface light transmitting portion.

3. The toothbrush according to claim 2, wherein the head portion includes sides that have outer peripheries, and the elastic portion is formed on at least a part of the outer peripheries of the sides of the head portion and in a substantially central region of the opposed surface except on the back-surface light transmitting portion.

4. The toothbrush according to claim 3, wherein the back-surface light transmitting portion is formed to have a cross section thereof curved from an outer periphery of a back surface of the head portion to a part of the outer peripheries of the sides, and surfaces of the elastic portion project from surfaces of respective light transmitting portions.

5. The toothbrush according to claim 1, wherein the elastic portion includes a shaft elastic body on the shaft in the vicinity of the head portion, and a surface of the shaft does not include the elastic body and is thereby provided with a shaft light transmitting portion.

6. A toothbrush comprising a head portion with a brush portion, a toothbrush body, and a shaft that connects the head portion and the toothbrush body,
the toothbrush body being provided with a light emitting device configured to irradiate light toward the head portion, the shaft being structured to permit the light to transmit or pass therethrough,
at least a surface of the head portion including an elastic portion, and
the elastic body being formed from a transparent material.

7. The toothbrush according to claim 2, wherein the elastic portion includes a shaft elastic body on the shaft in the vicinity of the head portion, and a surface of the shaft does not include the shaft elastic body and is thereby provided with a shaft light transmitting portion.

8. The toothbrush according to claim 3, wherein the elastic portion includes a shaft elastic body on the shaft in the vicinity of the head portion, and a surface of the shaft does not include the elastic body and is thereby provided with a shaft light transmitting portion.

9. The toothbrush according to claim 4, wherein the elastic portion includes a shaft elastic body on the shaft in the vicinity of the head portion, and a surface of the shaft does not include the elastic body and is thereby provided with a shaft light transmitting portion.

10. A toothbrush comprising a head portion with a brush portion located on a surface thereof, a toothbrush body, and a shaft that connects the head portion and the toothbrush body,
the toothbrush body being provided with a light emitting device that is configured to irradiate light toward the head portion, the shaft being structured to permit the light to transmit or pass therethrough,
at least a surface of the head portion including an elastic portion located thereon, and
a portion of the head portion not including the elastic portion located thereon and thereby provided with a head portion light transmitting portion.

11. The toothbrush according to claim 10, wherein the surface of the head portion on which the brush portion is provided does not include the elastic portion and is thereby formed with a brush-portion light transmitting portion, and at least a part of a surface opposed to the surface of the head portion on which the brush portion is provided does not include the elastic portion and is thereby provided with a back-surface light transmitting portion.

12. The toothbrush according to claim 1 1, wherein the head portion includes sides that have outer peripheries, and the elastic portion is formed on at least a part of the outer peripheries of the sides of the head portion and in a substantially central region of the opposed surface except on the back-surface light transmitting portion.

13. The toothbrush according to claim 12, wherein the back-surface light transmitting portion is formed to have a cross section thereof curved from an outer periphery of a back surface of the head portion to a part of the outer peripheries of the sides, and surfaces of the elastic portion project from surfaces of respective light transmitting portions.

14. The toothbrush according to claim 10, wherein the elastic portion includes a shaft elastic body on the shaft in the vicinity of the head portion, and a surface of the shaft does not include the elastic body and is thereby provided with a shaft light transmitting portion.

15. The toothbrush according to claim 11, wherein the elastic portion includes a shaft elastic body on the shaft in the vicinity of the head portion, and a surface of the shaft does not include the shaft elastic body and is thereby provided with a shaft light transmitting portion.

16. The toothbrush according to claim 12, wherein the elastic portion includes a shaft elastic body on the shaft in the vicinity of the head portion, and a surface of the shaft does not include the elastic body and is thereby provided with a shaft light transmitting portion.

17. The toothbrush according to claim 13, wherein the elastic portion includes a shaft elastic body on the shaft in the vicinity of the head portion, and a surface of the shaft does not include the elastic body and is thereby provided with a shaft light transmitting portion.
